(19) United States
(12) Patent Application Publication
(10) Pub. No.: US 2017/0248824 A1
(43) Pub. Date: Aug. 31, 2017

(54) TRANSMISSIVE SCREEN

(71) Applicant: Panasonic Intellectual Property Management Co., Ltd., Osaka (JP)

(72) Inventor: NOBUYUKI KOBAYASHI, Hyogo (JP)

(21) Appl. No.: 15/370,077

(22) Filed: Dec. 6, 2016

(30) Foreign Application Priority Data
Feb. 26, 2016 (JP) 2016-036224
Nov. 28, 2016 (JP) 2016-229727

(51) Int. Cl. G02F 1/1337; G02F 1/1334; G02F 1/137; G02F 1/1343

(52) U.S. Cl. CPC G02F 1/133784; G02F 1/13439; G02F 1/1337; G02F 1/1334; G02F 1/137; G02F 2001/13712

(57) ABSTRACT

A transmissive screen is capable of switching between a transmissive state for transmitting light and a reflective state for reflecting light, and includes a first transparent substrate and a second transparent substrate that are disposed face to face, a first transparent electrode and a second transparent electrode that are sandwiched between the first and second transparent substrates, a first alignment film and a second alignment film that are sandwiched between the first and second transparent electrodes, and a liquid crystal layer that is sandwiched between the first and second alignment films. The liquid crystal layer includes liquid crystal molecules and a polymeric material. The first alignment film has a first rubbing axis, and the second alignment film has a second rubbing axis. An angle between the first rubbing axis and the second rubbing axis is from 150° to 210° inclusive. The liquid crystal molecules have a negative dielectric anisotropy.

### BACKGROUND

1. Technical Field

The present disclosure relates to a transmissive screen.

2. Description of the Related Art

Conventionally, a screen that reflects all projected image light and transmits no image light has been used as a screen for displaying an image. On the other hand, in recent years, a transmissive screen has been developed. The transmissive screen displays projected image and, at the same time, transmits background light in a part where no image is displayed.

As such a transmissive screen, a transmissive screen that is capable of switching between a transmissive state for transmitting light and a reflective state for diffusing and reflecting light is often used. Such a transmissive screen, for example, displays an image projected from a projector so as to make the image visually recognizable when the transmissive screen is in a reflective state.

A polymer dispersed liquid crystal element (hereinbelow, referred to as a “PDLC”) that uses a liquid crystal material is being studied as such a transmissive screen capable of switching between a transmissive state and a reflective state. A normal-mode PDLC is known as the PDLC. The normal-mode PDLC is in a transmissive state (transparent state) when voltage is applied and in a reflective state (opaque state) when no voltage is applied (refer to Unexamined Japanese Patent Publication No. 2006-145973, Unexamined Japanese Patent Publication No. 2006-153982, and Unexamined Japanese Patent Publication No. 2006-227172, for example).

### SUMMARY

The present disclosure provides a transmissive screen that has a high contrast ratio and an excellent responsiveness.

The transmissive screen in the present disclosure is capable of switching between a transmissive state for transmitting light and a reflective state for reflecting light and includes a first transparent substrate and a second transparent substrate that are disposed face to face, a first transparent electrode and a second transparent electrode that are sandwiched between the first transparent substrate and the second transparent substrate, a first alignment film and a second alignment film that are sandwiched between the first transparent electrode and the second transparent electrode, and a liquid crystal layer that is sandwiched between the first alignment film and the second alignment film. The liquid crystal layer includes liquid crystal molecules and a polymeric material. The first alignment film has a first rubbing axis, and the second alignment film has a second rubbing axis. An angle between the first rubbing axis and the second rubbing axis is from 150° to 210° inclusive. The liquid crystal molecules have a negative dielectric anisotropy.

The transmissive screen in the present disclosure has a high contrast ratio and an excellent responsiveness.

### BRIEF DESCRIPTION OF THE DRAWINGS

FIG. 1 is a schematic sectional view of a transmissive screen according to an exemplary embodiment in a transmissive state;

FIG. 2 is a schematic sectional view of the transmissive screen according to the exemplary embodiment in a reflective state;

FIG. 3 is a schematic diagram of alignment films when an angle between rubbing axis (I) and rubbing axis (II) is 180°;

FIG. 4 is a schematic diagram of the alignment films when the angle between rubbing axis (I) and rubbing axis (II) is 150°; and

FIG. 5 is a schematic diagram illustrating a long axis direction and a short axis direction of a liquid crystal molecule.

### DETAILED DESCRIPTION

Hereinbelow, an exemplary embodiment will be described in detail with reference to the drawings in an appropriate manner. However, unnecessarily detailed description may be omitted. For example, detailed description of an already well-known matter and overlapping description of substantially the same configurations may be omitted in order to avoid the following description from becoming unnecessarily redundant and to make it easy for a person skilled in the art to understand the following description.

The accompanying drawings and the following description are provided so that a person skilled in the art can sufficiently understand the present disclosure. Therefore, the accompanying drawings and the following description are not intended to limit the subject matter defined in the claims.

First, a process of the present disclosure will be described.

In a normal-mode PDLC, voltage is constantly applied to a liquid crystal element in a transmissive state. Thus, power consumption of the liquid crystal element increases. Thus, in recent years, a reverse-mode PDLC (hereinbelow, referred to as an “R-PDLC”) has been considered. The R-PDLC is in a transmissive state when no voltage is applied and in a reflective state when voltage is applied.

However, a conventional R-PDLC does not have a sufficient contrast ratio as a transmissive screen. Further, a conventional R-PDLC also does not have a sufficient response speed in a change from a transmissive state to a reflective state and a sufficient response speed in a change from a reflective state to a transmissive state as a transmissive screen.

Thus, there is a demand for an R-PDLC that has a high contrast ratio, and has a high response speed in a change from a transmissive state to a reflective state and a high response speed in a change from a reflective state to a transmissive state.

In the present disclosure, the contrast ratio refers to a ratio value of a transmittance of a liquid crystal element in a transmissive state with respect to a transmittance of the liquid crystal element in a reflective state. A responsiveness described in the present specification refers to a characteristic relating to the response speed in a change from a transmissive state to a reflective state and the response speed in a change from a reflective state to a transmissive state. Further, “having an excellent responsiveness” means that both the above response speeds are high.

(Configuration)

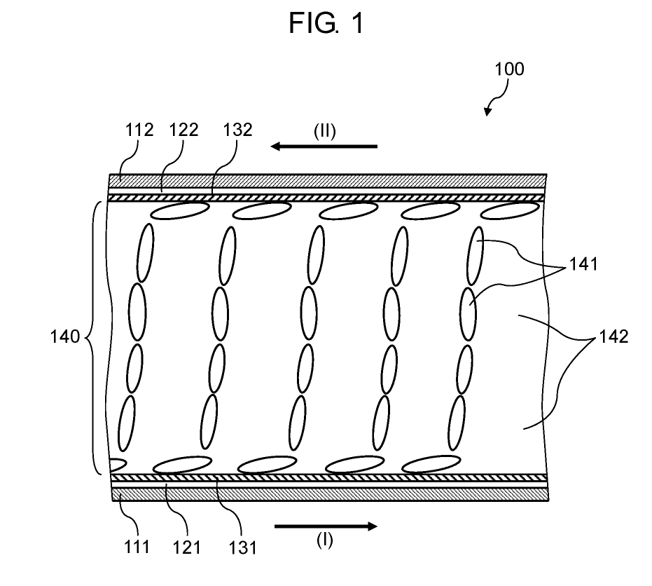

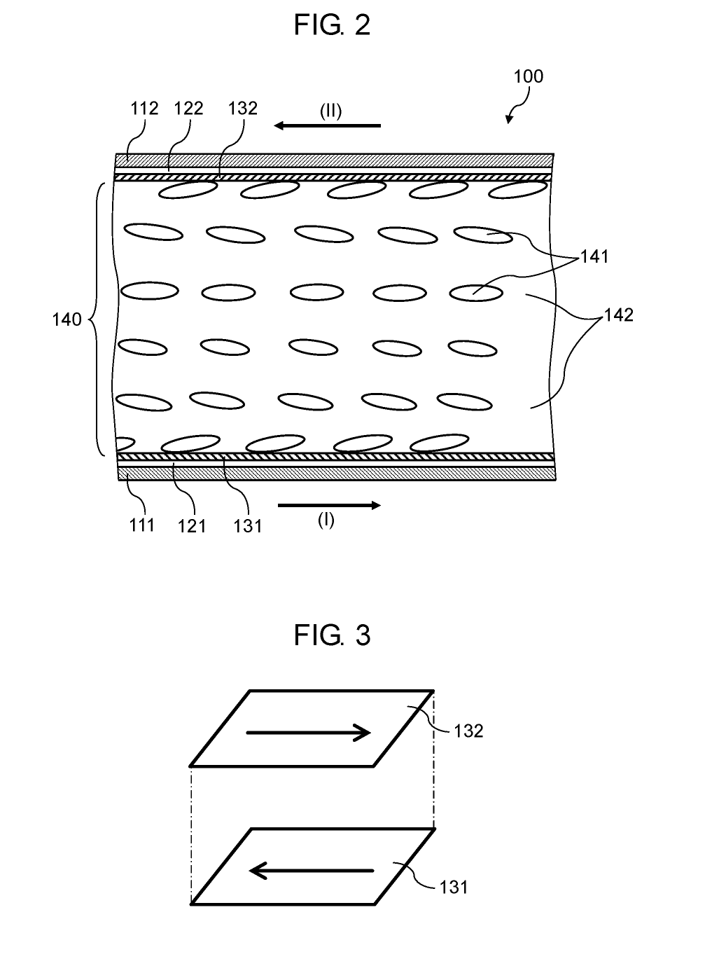

The present disclosure provides a transmissive screen capable of switching between a transmissive state for transmitting light and a reflective state for reflecting light. FIG. 1 is a schematic sectional view of transmissive screen 100 of an exemplary embodiment in a transmissive state. FIG. 2 is a schematic sectional view of transmissive screen 100 of the exemplary embodiment in a reflective state.

Transmissive screen 100 illustrated in FIGS. 1 and 2 is provided with transparent substrate 111 and transparent substrate 112 which are disposed face to face, transparent electrode 121 and transparent electrode 122 which are sandwiched between transparent substrate 111 and transparent substrate 112, alignment film 131 and alignment film 132 which are sandwiched between transparent electrode 121 and transparent electrode 122, and liquid crystal layer 140 which is sandwiched between alignment film 131 and alignment film 132. Liquid crystal layer 140 includes liquid crystal molecules 141 and polymeric material 142.

Transparent substrate 111 is an example of a first transparent substrate. Transparent substrate 112 is an example of a second transparent substrate. Transparent electrode 121 is an example of a first transparent electrode. Transparent electrode 122 is an example of a second transparent electrode. Alignment film 131 is an example of a first alignment film. Alignment film 132 is an example of a second alignment film.

Transparent substrate 111 supports transparent electrode 121 and alignment film 131. Transparent substrate 112 supports transparent electrode 122 and alignment film 132. For example, transparent substrate 111 may be disposed at a back side of transmissive screen 100, and transparent substrate 112 may be disposed at a front side (visually recognizable side) of transmissive screen 100.

(Rubbing Axis of Alignment Film)

Alignment film 131 has rubbing axis (I) which faces a first direction, and alignment film 132 has rubbing axis (II) which faces a second direction. An angle between rubbing axis (I) and rubbing axis (II) is from 150° to 210° inclusive. That is, an angle between the first direction and the second direction is from 150° to 210° inclusive. When the angle between rubbing axis (I) and rubbing axis (II) is within this angle range, a transmittance of transmissive screen 100 is high in a transmissive state, and a responsiveness of transmissive screen 100 is excellent.

For example, the angle between rubbing axis (I) and rubbing axis (II) may be from 160° to 200° inclusive or from 170° to 190° inclusive according to a liquid crystal display type of liquid crystal layer 140.

In the present disclosure, a state in which the angle between rubbing axis (I) and rubbing axis (II) is within the range from 150° to 210° inclusive corresponds to a state in which rubbing axis (I) and rubbing axis (II) face opposite directions. In the present disclosure, such a state is referred to as an “antiparallel” state.

Since rubbing axis (I) and rubbing axis (II) are in an antiparallel state, transmissive screen 100 has a high contrast ratio and an excellent responsiveness. The configuration of the present disclosure increases the transmittance of transmissive screen 100 in a transmissive state and reduces the transmittance of transmissive screen 100 in a reflective state. Thus, the contrast ratio of transmissive screen 100 is improved.

Hereinbelow, a concrete example of the “antiparallel” state in the present disclosure will be described.

FIG. 3 is a schematic diagram of alignment film 131 and alignment film 132 when the angle between rubbing axis (I) and rubbing axis (II) is 180°. In FIG. 3, an arrow on alignment film 131 indicates rubbing axis (I) of alignment film 131, and an arrow on alignment film 132 indicates rubbing axis (II) of alignment film 132. In this example, the angle between rubbing axis (I) of alignment film 131 and rubbing axis (II) of alignment film 132 is 180°, and rubbing axis (I) and rubbing axis (II) are in an antiparallel state.

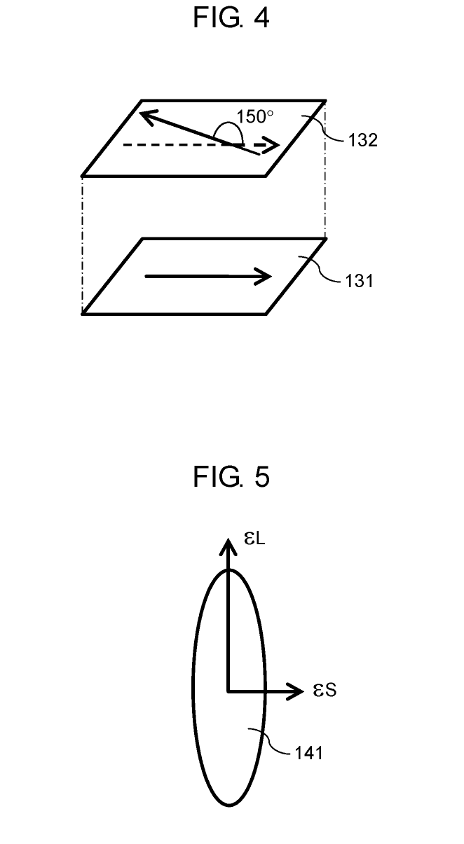

FIG. 4 is schematic diagram of alignment film 131 and alignment film 132 when the angle between rubbing axis (I) and rubbing axis (II) is 150°. In FIG. 4, an arrow on alignment film 131 indicates rubbing axis (I) of alignment film 131, and a solid arrow on alignment film 132 indicates rubbing axis (II) of alignment film 132. A dashed arrow on alignment film 132 indicates an axis that faces the same direction as rubbing axis (I) of alignment film 131. In this example, the angle between rubbing axis (I) of alignment film 131 and rubbing axis (II) of alignment film 132 is 150°, and rubbing axis (I) and rubbing axis (II) are in an antiparallel state.

For description, FIG. 3 and FIG. 4 describe a relationship between alignment film 131 and alignment film 132.

Here, a state in which the angle between rubbing axis (I) and rubbing axis (II) is from −30° to 30° inclusive is referred to as a “parallel” state.

In transmissive screen 100, the angle between rubbing axis (I) and rubbing axis (II) may be defined according to a liquid crystal display type to be used within a range of the present disclosure.

(Twist Angle)

A twist angle can be applied to liquid crystal molecules 141 included in liquid crystal layer 140 according to the angle between rubbing axis (I) and rubbing axis (II). In the present disclosure, the twist angle is an angle of twist of liquid crystal molecules 141 which are present between alignment film 131 and alignment film 132. In the present disclosure, a twist angle in a clockwise direction is plus and a twist angle in a counterclockwise direction is minus with respect to rubbing axis (I) of alignment film 131. When the angle between rubbing axis (I) and rubbing axis (II) is 150°, for example, a twist angle of −30°+180°×n (n is an integer) can be applied to liquid crystal molecules 141. In the above formula, n represents the number of twists of liquid crystal molecules 141. When n=2, liquid crystal molecules 141 are twisted twice. For example, a state in which the angle between rubbing axis (I) and rubbing axis (II) is 150° and n=1 indicates a state in which liquid crystal molecules 141 are first rotated by 180° and then further rotated by −30°.

When the angle between rubbing axis (I) and rubbing axis (II) is 210°, for example, a twist angle of 30°+180°×n (n is an integer) can be applied to liquid crystal molecules 141. In the above formula, n represents the number of twists of liquid crystal molecules 141. When n=2, liquid crystal molecules 141 are twisted twice.

When the angle between rubbing axis (I) and rubbing axis (II) is 180°, for example, a twist angle of 0°+180°×n (n is an integer) can be applied to liquid crystal molecules 141. In the above formula, n represents the number of twists of liquid crystal molecules 141. When n=2, liquid crystal molecules 141 are twisted twice.

In this manner, a function of liquid crystal layer 140 is more effectively exhibited by applying a twist angle to liquid crystal molecules 141 according to a liquid crystal display type to be used within the range of the present disclosure.

(Pretilt Angle)

In the present disclosure, a pretilt angle is a tilt angle of liquid crystal molecules 141 with respect to the transparent substrates. In the present disclosure, a pretilt angle of liquid crystal molecules 141 that are in contact with alignment film 131 and liquid crystal molecules 141 that are in contact with alignment film 132 is, for example, from 0° to 80° inclusive. When the pretilt angle of liquid crystal molecules 141 that are in contact with each of the alignment films is within such a range, transmissive screen 100 can have an excellent contrast ratio.

In the present disclosure, a pretilt angle in a transmissive state and a pretilt angle in a reflective state may be substantially equal to each other or different from each other.

The pretilt angle of liquid crystal molecules 141 that are in contact with alignment film 131 and liquid crystal molecules 141 that are in contact with alignment film 132 may be from 0° to 45° inclusive. This enables transmissive screen 100 to have a more excellent contrast ratio. The pretilt angle of liquid crystal molecules 141 that are in contact with alignment film 131 and liquid crystal molecules 141 that are in contact with alignment film 132 may be from 0° to 30° inclusive. This enables transmissive screen 100 to have a more excellent contrast ratio. The pretilt angle of liquid crystal molecules 141 that are in contact with alignment film 131 and liquid crystal molecules 141 that are in contact with alignment film 132 may be from 0° to 20° inclusive. This enables transmissive screen 100 to have a further more excellent contrast ratio.

A pretilt angle of liquid crystal molecules 141 that are in contact with alignment film 131 and a pretilt angle of liquid crystal molecules 141 that are in contact with alignment film 132 may be equal to each other or different from each other.

For example, the pretilt angle of liquid crystal molecules 141 that are in contact with alignment film 131 may be from 5° to 50° inclusive, and the pretilt angle of liquid crystal molecules 141 that are in contact with alignment film 132 may be from 0° to 50° inclusive.

(Liquid Crystal Layer)

In the present disclosure, liquid crystal layer 140 is a reverse-mode liquid crystal layer which includes liquid crystal molecules 141 and polymeric material 142.

Reverse-mode liquid crystal layer 140 is in a transmissive state for transmitting light in a non-voltage applied state and in a reflective state for diffusing and reflecting light in a voltage applied state. Here, the “non-voltage applied state” is a state in which no voltage is applied between transparent electrode 121 and transparent electrode 122. The “voltage applied state” is a state in which voltage is applied between transparent electrode 121 and transparent electrode 122.

Specifically, in the non-voltage applied state, liquid crystal molecules 141 are aligned so that a long axis direction of liquid crystal molecules 141 extends along a direction perpendicular to the transparent substrates (refer to FIG. 1). As described below, a difference between a refractive index in the long axis direction of liquid crystal molecules 141 and a refractive index of polymeric material 142 is small. Thus, light that has entered liquid crystal layer 140 is hardly diffused and emitted from liquid crystal layer 140. Therefore, transmissive screen 100 is in a transmissive state in the non-voltage applied state.

The difference between the refractive index in the long axis direction of liquid crystal molecules 141 in the non-voltage applied state and the refractive index of polymeric material 142 in the non-voltage applied state is, for example, 0.05 or less. When the difference in refractive index is within such a range, transmissive screen 100 has a high transmittance in a transmissive state. The difference between the refractive index in the long axis direction of liquid crystal molecules 141 in the non-voltage applied state and the refractive index of polymeric material 142 in the non-voltage applied state may be, for example, 0.01 or less. When the difference in refractive index is within such a range, transmissive screen 100 has a higher transmittance in a transmissive state.

In the present disclosure, when no voltage is applied to transmissive screen 100, transmissive screen 100 is in a transmissive state. Thus, for example, when transmissive screen 100 is used in a room or in a vehicle, a feeling of oppression caused by transmissive screen 100 is reduced. Further, transmissive screen 100 has an excellent transmittance in the non-voltage applied state. Thus, transmissive screen 100 can be applied to various places without obstructing visibility.

Transmissive screen 100 in the present disclosure is provided with reverse-mode liquid crystal layer 140. Thus, transmissive screen 100 can also be used for a purpose in which a time of displaying an image (a time in a reflective state) is shorter than a time of displaying no image (a time in a transmissive state). Such a use form enables power-saving driving of transmissive screen 100.

On the other hand, in the voltage applied state, liquid crystal molecules 141 rotate so that a short axis direction of liquid crystal molecule 141 extends along a direction of an electric field (refer to FIG. 2). As described below, a difference between a refractive index in the short axis direction of liquid crystal molecules 141 and the refractive index of polymeric material 142 is large. Thus, light that has entered liquid crystal layer 140 is diffused and reflected inside liquid crystal layer 140. Therefore, transmissive screen 100 becomes a reflective state.

The “non-voltage applied state” includes, not only a state in which no voltage is applied between transparent electrode 121 and transparent electrode 122, but also a state in which a voltage that does not substantially act on liquid crystal molecules 141 is applied between transparent electrode 121 and transparent electrode 122.

As described below, liquid crystal molecules 141 and polymeric material 142 may be different materials. Each of liquid crystal molecules 141 often has a long axis direction and a short axis direction in shape, and may have a shape extending in the long axis direction. An initial aligned state of liquid crystal molecules 141 in liquid crystal layer 140 can be set according to liquid crystal molecules 141 and polymeric material 142 to be used. For example, the pretilt angle may vary according to an initial aligned state in each liquid crystal display mode.

In the present disclosure, liquid crystal molecules 141 have a negative dielectric anisotropy. The negative dielectric anisotropy refers to a property having a relationship of ∈L−∈S<0 between a dielectric constant (∈L) in the long axis direction and a dielectric constant (∈S) in the short axis direction in a schematic diagram of liquid crystal molecule 141 illustrated in FIG. 5.

In the present disclosure, for example, a value of ∈L −∈S may be within a range from −30 to −2.5 inclusive. When liquid crystal molecules 141 have a negative dielectric anisotropy within such a range, transmissive screen 100 has a high contrast ratio and an excellent responsiveness. When liquid crystal molecules 141 have a negative dielectric anisotropy, liquid crystal molecules 141 may rotate so that the short axis direction of liquid crystal molecules 141 extends along the direction of the electric field.

When ∈L−∈S>0, the dielectric anisotropy is positive. When ∈L−∈S=0, the dielectric constant has no anisotropy.

A thickness of liquid crystal layer 140 is not particularly limited to any thickness. The thickness of liquid crystal layer 140 is, for example, from 2 μm to 20 μm inclusive. When the thickness of the liquid crystal layer 140 is 2 μm or more, transmissive screen 100 can more effectively diffuse and reflect light in a reflective state. When the thickness of the liquid crystal layer 140 is 5 μm or more, transmissive screen 100 can further more effectively diffuse and reflect light in a reflective state. When the thickness of the liquid crystal layer 140 is 2 μm or more, transmissive screen 100 can reduce the light transmittance to 1% or less in a reflective state. When the thickness of the liquid crystal layer 140 is 20 μm or less, transmissive screen 100 can obtain effects of low drive voltage and energy saving.

The thickness of liquid crystal layer 140 can be controlled using, for example, a spherical spacer which is interposed between the alignment films. When a diameter of the spacer is from 0.2 μm to 20 μm inclusive, the thickness of liquid crystal layer 140 is easily uniformly maintained.

Hereinbelow, constituent members included in transmissive screen 100 in the present disclosure will be described in more detail. However, the constituent members of the present disclosure are not limited to the described constituent members.

(Transparent Substrate)

Examples of a constituent material of transparent substrate 111 and transparent substrate 112 include a glass material such as quartz glass and a plastic material such as polyethylene terephthalate. Among these materials, a glass material such as quartz glass is particularly preferably used as the constituent material of each of the transparent substrates. Accordingly, it is possible to obtain transmissive screen 100 that has a more excellent stability with less warpage and deformation.

(Transparent Electrode)

Transparent electrode 121 is formed on an inner face (a face facing liquid crystal layer 140) of transparent substrate 111. Transparent electrode 122 is formed on an inner face (a face facing liquid crystal layer 140) of transparent substrate 112. Each of the transparent electrodes has electric conductivity. Each of the transparent electrodes includes, for example, indium tin oxide (ITO), indium oxide (In₂O₃), or tin oxide (SnO₂).

(Alignment Film)

Alignment film 131 is formed on an inner face (a face facing liquid crystal layer 140) of transparent electrode 121. Alignment film 132 is formed on an inner face (a face facing liquid crystal layer 140) of transparent electrode 122.

Each of the alignment films may be an alignment film that is rubbing-processed so that the pretilt angle of liquid crystal molecules 141 that are in contact with each of the alignment films is within a range from 0° to 80° inclusive.

In each of the rubbing-processed alignment films, a width and a depth of a rubbing groove are appropriately set according to a size of each of liquid crystal molecules 141. The width of the rubbing groove is, for example, from 10 nm to 100 nm inclusive. The depth of the rubbing groove is, for example, from 10 nm to 100 nm inclusive. When the width and the depth of the rubbing groove is within such a range, the pretilt angle of liquid crystal molecules 141 that are in contact with each of the alignment films can be set within the range from 0° to 80° inclusive. Accordingly, transmissive screen 100 has a high contrast ratio and an excellent responsiveness.

A method for applying an alignment regulation force to each of the alignment films by rubbing is not particularly limited to any method. Specifically, the face facing liquid crystal layer 140 of each of the alignment films is rubbed to apply an alignment regulation force capable of aligning liquid crystal molecules 141 to each of the alignment films. The alignment regulation force can be controlled by a condition such as a rotation speed of a rubbing roller or a pressure of the rubbing roller against the substrate. A known technique may be used as the rubbing method.

Each of the alignment films includes, for example, at least one kind of material that is generally used as a liquid crystal alignment film such as polyamic acid, polyimide, lecithin, nylon, or polyvinyl alcohol.

(Liquid Crystal Layer)

Liquid crystal layer 140 is a reverse-mode liquid crystal layer which includes liquid crystal molecules 141 and polymeric material 142. Liquid crystal layer 140 has a structure in which a network of polymeric material 142 is distributed between liquid crystal molecules 141.

Liquid crystal layer 140 is formed from a mixture of a polymeric precursor such as liquid crystal monomers and liquid crystal molecules 141. Specifically, the mixture is aligned by each of the alignment films. Then, an energy such as ultraviolet rays is applied to the mixture to polymerize the polymeric precursor. Accordingly, the polymeric precursor is polymerized with the aligned state maintained and becomes polymeric material 142 which has an alignment regulation force. Liquid crystal molecules 141 are phase-separated from the mixture. Then, liquid crystal molecules 141 that are not in contact with each of the alignment films can be aligned by the alignment regulation force of polymeric material 142.

The polymeric precursor includes a material that is dissolvable in liquid crystal molecules 141. Polymeric material 142 includes, for example, a material that has a benzene skeleton in a polymer. Preferably, polymeric material 142 includes a material that has a biphenyl skeleton. Polymeric material 142 may not have a benzene skeleton, and any polymer that is aligned together with liquid crystal molecules 141 can be used. For example, an acrylic, methacrylic, epoxy, or silicone polymeric material can be used as polymeric material 142.

Concrete examples of the polymeric precursor include a methacrylate ester or acrylic ester of biphenyl methanol or naphthol and any derivative of a compound of these materials. As a concrete example of the polymeric precursor, a material obtained by mixing a methacrylate ester or acrylic ester derivative of bisphenol to any of the above materials may be used. As another example of the polymeric precursor, an α-methyl styrene or epoxy resin may be used.

As polymeric material 142, any combination of the above polymeric materials may be used, or a commercially available polymeric material may be used.

On the other hand, liquid crystal molecules 141 may be any material having a negative dielectric anisotropy and can be appropriately selected from known liquid crystal materials. For example, a nematic liquid crystal material can be used as liquid crystal molecules 141. Further, as liquid crystal molecules 141, a plurality of liquid crystal materials may be combined and used, or a commercially available liquid crystal material may be used.

Further, for example, a material whose refractive index in a long axis direction is substantially equal to the refractive index of polymeric material 142 and whose refractive index in a short axis direction is sufficiently different from the refractive index of polymeric material 142 may be used as liquid crystal molecules 141. That is, the refractive index in the long axis direction of liquid crystal molecules 141 may be sufficiently different from the refractive index in the short axis direction of liquid crystal molecules 141. A difference between the refractive index in the long axis direction of liquid crystal molecules 141 and the refractive index in the short axis direction of liquid crystal molecules 141 is, for example, 0.2.

In the mixture of liquid crystal molecules 141 and the polymeric precursor, a mass ratio (liquid crystal molecules 141:polymeric precursor) is within a range from 99.5:0.5 to 95.5:4.5 inclusive. When a ratio of the polymeric precursor is equal to or higher than the mass ratio of 99.5:0.5, liquid crystal layer 140 is easily formed. On the other hand, when the ratio of the polymeric precursor is equal to or lower than the mass ratio of 95.5:4.5, the response speed and the contrast ratio of transmissive screen 100 is increased.

The response speed from a transmissive state to a reflective state is desirably, for example, 10 ms or less. The response speed from a reflective state to a transmissive state is desirably, for example, 50 ms or less. When both the response speeds are within these ranges, transmissive screen 100 can exhibit an excellent response also to a moving image.

The contrast ratio of transmissive screen 100 is desirably, for example, 6 or more. When the contrast ratio is within such a range, transmissive screen 100 can maintain an extremely high display quality.

The response speed and the contrast ratio can be measured, for example, by a combination of the following devices.

Signal generator: WF-1974 (manufactured by NF CORPORATION)

Power source: HAS4052 (manufactured by NF CORPORATION)

Oscilloscope: TDS2024C (manufactured by Tektronix, Inc.)

Laser: He-Ne laser

When a known liquid crystal material is used as liquid crystal molecules 141, various kinds of compounds such as a biphenyl compound, a phenyl cyclohexane compound, a cyclohexyl cyclohexane compound, a tolan compound, and a pyridine compound as described in “liquid crystal device handbook (NIHON KOGYO SHIMBUN, LTD.) or a mixture including at least one of these compounds can be used. Further, when a chiral material is used as liquid crystal molecules 141, there is no particular limitation. A known chiral material may be used or a chiral material of a synthetic product may be used as liquid crystal molecules 141.

(Transmissive Screen)

Transmissive screen 100 in the present disclosure can be used for various purposes. Transmissive screen 100 is used as, for example, a display device that includes a transmissive screen disposed on an inner side of a windshield of a motor vehicle or an airplane, a wearable device that includes a small transmissive screen disposed on glasses, or a display device that includes a transmissive screen disposed on a window glass.

Transmissive screen 100 may not necessarily be used for a purpose of displaying a projected image. Transmissive screen 100 may have a plurality of pixels. Accordingly, transmissive screen 100 can display an image by switching between a transmissive state and a reflective state in each of the pixels.

Transmissive screen 100 achieves a reflective state by diffusing and reflecting light incident along a direction perpendicular to each of the transparent substrates in the voltage applied state. That is, transmissive screen 100 can control light incident on transmissive screen 100 without a polarizing plate.

(Effects)

As described above, transmissive screen 100 in the present disclosure has a high contrast ratio and an excellent responsiveness. Further, transmissive screen 100 has a high transmittance in the non-voltage applied state. Thus, transmissive screen 100 can be used in various forms. Further, transmissive screen 100 is in a transmissive state in the non-voltage applied state. Thus, when transmissive screen 100 is used mainly in a transmissive state, power consumption can be largely reduced compared to a conventional transmissive screen.

### EXAMPLES

The present disclosure will be described in more detail on the basis of the following examples. However, the present disclosure is not limited to these examples. In the examples, “%” is based on mass unless otherwise noted.

### Example 1

(Preparation of Liquid Crystal Molecules and Polymeric Precursor)

In Example 1, liquid crystal molecules 141 are a nematic liquid crystal material that exhibits a negative dielectric anisotropy (product number: 820050 manufactured by LCC Corporation). Hereinbelow, the liquid crystal material is also referred to as liquid crystal material A. A polymeric precursor is acrylate A-DCP (manufactured by Shin-Nakamura Chemical Co., Ltd.). A photopolymerization initiator is Irgacure 184 (manufactured by BASF).

The polymeric precursor of 1 mass % was mixed to liquid crystal material A of 99 mass %. Then, the photopolymerization initiator of 3 mass % was added and mixed to the polymeric precursor of 1 mass %. In this manner, a mixture of liquid crystal material A and the polymeric precursor was prepared.

(Manufacture of Liquid Crystal Cell)

In Example 1, transparent substrate 111 and transparent substrate 112 are each glass substrates. Transparent electrode 121 and transparent electrode 122 each includes ITO. Alignment film 131 and alignment film 132 are each parallel alignment films each having a thickness of approximately 50 nm (JALS-1636-R1 manufactured by JSR Corporation).

Two transparent substrates on each of which a transparent electrode is formed were prepared. Alignment films were disposed on the respective transparent films. The alignment films were rubbed with a predetermined strength to form rubbing axis (I) in one of the alignment films and form rubbing axis (II) in the other alignment film. The transparent substrates were disposed face to face in such a manner that an angle between rubbing axis (I) and rubbing axis (II) has a relationship of 180°±20° in average. Further, a spacer having a diameter of 10 μm (manufactured by SEKISUI CHEMICAL CO., LTD.) was interposed between the alignment films, and the transparent substrates were brought into overlap with each other. Then, a periphery of each of the transparent substrates except an injection port was sealed using a photo-curable sealant (Photolec (registered trademark) manufactured by SEKISUI CHEMICAL CO., LTD.) to manufacture a liquid crystal cell.

(Manufacture of Transmissive Screen)

The obtained liquid crystal cell was placed on a hot plate heated to 130° C., and the mixture of liquid crystal material A and the polymeric precursor was injected through the injection port. Then, ultraviolet rays having an intensity of 10 mW/cm² was applied to the liquid crystal cell for 100 seconds. Then, the liquid crystal cell was slowly cooled to a room temperature to manufacture a transmissive screen.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 2 ms, and a response speed from a reflective state to a transmissive state was 30 ms. Thus, the responsiveness was excellent. A contrast ratio of the transmissive screen was 10, and thus excellent. The contrast ratio and the response speed were measured by a combination of the following devices.

Signal generator: WF-1974 (manufactured by NF CORPORATION)

Power source: HAS4052 (manufactured by NF CORPORATION)

Oscilloscope: TDS2024C (manufactured by Tektronix, Inc.)

Laser: He-Ne laser

A pretilt angle of liquid crystal molecules in contact with each of the alignment films was 12°.

### Example 2

In Example 2, the spacer was changed to a space having a diameter of 5 μm in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 0.7 ms, and a response speed from a reflective state to a transmissive state was 1 ms. Thus, the responsiveness was extremely excellent. A contrast ratio of the transmissive screen was 9, and thus excellent. A pretilt angle of liquid crystal molecules in contact with each of the alignment films was 8°.

### Example 3

In Example 3, liquid crystal material A was changed to liquid crystal material B having a lower nematic-isotropic transition temperature than liquid crystal material A in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 3 ms, and a response speed from a reflective state to a transmissive state was 30 ms. Thus, the responsiveness was excellent. A contrast ratio of the transmissive screen was 8, and thus excellent. A pretilt angle of liquid crystal molecules in contact with each of the alignment films was 11°.

### Example 4

In Example 4, an amount of liquid crystal material A was changed to 97 mass %, and an amount of the polymeric precursor was changed to 3 mass % in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 20 ms. Thus, the responsiveness was excellent. A contrast ratio of the transmissive screen was 7, and thus excellent. A pretilt angle of liquid crystal molecules in contact with each of the alignment films was 10°.

### Example 5

In Example 5, the amount of liquid crystal material A was changed to 96 mass %, and the amount of the polymeric precursor was changed to 4 mass % in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 30 ms. Thus, the responsiveness was excellent. A contrast ratio of the transmissive screen was 7, and thus excellent. A pretilt angle of liquid crystal molecules in contact with each of the alignment films was 10°.

### Example 6

In Example 6, liquid crystal material A was changed to liquid crystal material C having a larger ∈L−∈S than liquid crystal material A in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 35 ms. Thus, the responsiveness was excellent. A contrast ratio of the transmissive screen was 8, and thus excellent. A pretilt angle of liquid crystal molecules in contact with each of the alignment films was 10°.

### Comparative Example 1

In Comparative Example 1, liquid crystal material A was changed to nematic liquid crystal material D having a positive dielectric anisotropy in Example 1. Except for this, a transmissive screen was manufactured in the same manner as Example 1, and various evaluations were performed.

When ultraviolet rays were applied to the liquid crystal cell and the liquid crystal cell was then slowly cooled to a room temperature, the transmissive screen was opaque. When voltage of 40 V was applied to the opaque transmissive screen, the transmissive screen became more opaque. However, the transmissive screen did not become a transmissive state even when the transmissive screen was brought into the non-voltage applied state. Thus, a response speed and a contrast ratio could not be measured.

### Comparative Example 2

In Comparative Example 2, the angle between rubbing axis (I) and rubbing axis (II) was set to 0° to change rubbing axis (I) and rubbing axis (II) to a parallel state in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 70 ms. Thus, the response speed was extremely low. A contrast ratio of the transmissive screen was 3, and thus insufficient. A pretilt angle of liquid crystal molecules in contact with each of the alignment films was 20°.

### Comparative Example 3

In Comparative Example 3, a transmissive screen was manufactured using no alignment film in Example 1. Except for this, the transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 20 ms, and a response speed from a reflective state to a transmissive state was 100 ms. Thus, the response speed was extremely low. A contrast ratio of the transmissive screen was 4, and thus insufficient. A pretilt angle of liquid crystal molecules in contact with each of the alignment films was 10°.

### Comparative Example 4

In Comparative Example 4, an amount of liquid crystal material B was changed to 95 mass %, and an amount of the polymeric precursor was changed to 5 mass % in Example 3. Except for this, a transmissive screen was manufactured in the same manner as Example 3, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 60 ms. Thus, the response speed was low. A contrast ratio of the transmissive screen was 3, and thus insufficient. A pretilt angle of liquid crystal molecules in contact with each of the alignment films was 20°.

### Comparative Example 5

In Comparative Example 5, each of the alignment films was changed from a horizontal alignment film to a vertical alignment film in Example 1. Except for this, a transmissive screen was manufactured in the same manner as Example 1, and various evaluations were performed.

The obtained transmissive screen exhibited a transmissive state when no voltage was applied. On the other hand, when voltage of 40 V was applied to the transmissive screen, the transmissive screen became opaque and exhibited a reflective state. A response speed of the transmissive screen was measured. A response speed from a transmissive state to a reflective state was 5 ms, and a response speed from a reflective state to a transmissive state was 10 ms. A contrast ratio of the transmissive screen was 3, and thus insufficient. A pretilt angle of liquid crystal molecules in contact with each of the alignment films was 88°.

### Comparative Example 6

In Comparative Example 6, liquid crystal material A was changed to liquid crystal material E having a larger ∈L−∈S than liquid crystal material C in Example 1. Except for this, a transmissive screen was manufactured in the same manner as Example 1, and various evaluations were performed.

The obtained transmissive screen exhibited a transmissive state when no voltage was applied. On the other hand, even when voltage of 40 V was applied to the transmissive screen, the transmissive screen did not exhibit a reflective state. Thus a response speed and a contrast ratio could not be measured.

TABLE 1 shows details of a composition ratio and an evaluation result relating to each of the examples. TABLE 2 shows details of a composition ratio and an evaluation result relating to each of the comparative examples. In each of the tables, Δn represents a difference between the refractive index in the long axis direction of liquid crystal molecules 141 and the refractive index in the short axis direction of liquid crystal molecules 141. Further, NI POINT represents the nematic-isotropic transition temperature.

TABLE 1

| | EXAMPLE 1 | EXAMPLE 2 | EXAMPLE 3 | EXAMPLE 4 | EXAMPLE 5 | EXAMPLE 6 |
|---|---|---|---|---|---|---|
| LIQUID CRYSTAL MATERIAL | A | A | B | A | A | C |
| ∈L-∈S | −5 | −5 | −5 | −5 | −5 | −3.7 |
| Δn | 0.2 | 0.2 | 0.2 | 0.2 | 0.2 | 0.2 |
| NI POINT | 105 | 105 | 104 | 105 | 105 | 103 |
| LIQUID CRYSTAL | 99:1 | 99:1 | 99:1 | 97:3 | 96:4 | 99:1 |
| MATERIAL:PRECURSOR | | | | | | |
| ALIGNMENT AXIS | ANTI | ANTI | ANTI | ANTI | ANTI | ANTI |
| DIRECTION | PARALLEL | PARALLEL | PARALLEL | PARALLEL | PARALLEL | PARALLEL |
| ALIGNMENT FILM | HORIZONTAL | HORIZONTAL | HORIZONTAL | HORIZONTAL | HORIZONTAL | HORIZONTAL |
| LIQUID CRYSTAL LAYER | 10 | 5 | 10 | 10 | 10 | 10 |
| THICKNESS (μm) | | | | | | |
| RESPONSE SPEED | 2 | 0.7 | 3 | 5 | 5 | 5 |
| TRANSMISSION→RE- | | | | | | |
| FLECTION (ms) | | | | | | |
| REFLECTION→TRANS- | 30 | 1 | 30 | 20 | 30 | 35 |
| MISSION (ms) | | | | | | |
| CONTRAST RATIO | 10 | 9 | 8 | 7 | 7 | 8 |
| PRETILT ANGLE | 12 | 8 | 11 | 10 | 10 | 10 |
| (°) | | | | | | |

TABLE 2

| | COMPARATIVE | COMPARATIVE | COMPARATIVE | COMPARATIVE | COMPARATIVE | COMPARATIVE |
|---|---|---|---|---|---|---|
| | EXAMPLE 1 | EXAMPLE 2 | EXAMPLE 3 | EXAMPLE 4 | EXAMPLE 5 | EXAMPLE 6 |
| LIQUID CRYSTAL MATERIAL | D | A | A | B | A | E |
| ∈L-∈S | +10 | −5 | −5 | −5 | −5 | −2.4 |
| Δn | 0.2 | 0.2 | 0.2 | 0.2 | 0.2 | 0.2 |
| NI POINT | 108 | 105 | 105 | 104 | 105 | 102 |
| LIQUID CRYSTAL | 99:1 | 99:1 | 99:1 | 95:5 | 99:1 | 99:1 |
| MATERIAL:PRECURSOR | | | | | | |
| ALIGNMENT AXIS | ANTI | PARALLEL | N/A | ANTI | N/A | ANTI |
| DIRECTION | PARALLEL | | | PARALLEL | | PARALLEL |
| ALIGNMENT FILM | HORIZONTAL | HORIZONTAL | N/A | HORIZONTAL | VERTICAL | HORIZONTAL |
| LIQUID CRYSTAL LAYER | 10 | 10 | 10 | 10 | 10 | 10 |
| THICKNESS (μm) | | | | | | |
| RESPONSE SPEED | — | 5 | 20 | 5 | 5 | — |
| TRANSMISSION→RE- | | | | | | |
| FLECTION (ms) | | | | | | |
| REFLECTION→TRANS- | — | 70 | 100 | 60 | 10 | — |
| MISSION (ms) | | | | | | |
| CONTRAST RATIO | — | 3 | 4 | 3 | 3 | — |
| PRETILT ANGLE | 15 | 20 | 10 | 20 | 88 | 10 |
| (°) | | | | | | |

As described above, in transmissive screen 100, rubbing axis (I) and rubbing axis (II) are in an antiparallel state, and liquid crystal molecules 141 have a negative dielectric anisotropy. Thus, transmissive screen 100 has a high contrast ratio and an excellent responsiveness. However, when liquid crystal molecules 141 and the polymeric precursor are prepared at an inappropriate ratio in the mixture of liquid crystal molecules 141 and the polymeric precursor, transmissive screen 100 may not have a sufficient contrast ratio and a sufficient responsiveness. When ∈L−∈S is not within an appropriate range, transmissive screen 100 may not be driven.

The above results show that transmissive screen 100 in each of the above examples has a high contrast ratio and an excellent responsiveness. Further, transmissive screen 100 has a high transmittance in the non-voltage applied state. Thus, transmissive screen 100 can be used in various forms. Further, transmissive screen 100 is in a transmissive state in the non-voltage applied state. Thus, transmissive screen 100 can largely reduce power consumption compared to a conventional transmissive screen.

As described above, the exemplary embodiment has been described as an example of the technique in the present disclosure. Thus, the accompanying drawings and detailed description have been provided.

Therefore, in order to illustrate the technique, not only essential elements for solving the problems, but also inessential elements for solving the problems may be included in the elements described in the accompanying drawings or in the detailed description. Therefore, such inessential elements should not be immediately determined as essential elements because of their presence in the accompanying drawings or in the detailed description.

Further, since the exemplary embodiment described above is merely provided for illustrating the technique in the present disclosure, various modifications, replacements, additions, and omissions can be made within the scope of the claims or equivalents thereof.

The present disclosure is useful as a transmissive screen that has a high contrast ratio and an excellent responsiveness. Specifically, the present disclosure is applicable to an on-vehicle display device that includes a transmissive screen disposed on a head up display, a navigation device, a digital meter, or a console panel, a wearable device, and a display device that includes a transmissive screen disposed on a window glass.

What is claimed is:

1. A transmissive screen capable of switching between a transmissive state for transmitting light and a reflective state for reflecting light, the transmissive screen comprising:
a first transparent substrate and a second transparent substrate that are disposed face to face;
a first transparent electrode and a second transparent electrode that are sandwiched between the first transparent substrate and the second transparent substrate;
a first alignment film and a second alignment film that are sandwiched between the first transparent electrode and the second transparent electrode; and
a liquid crystal layer that is sandwiched between the first alignment film and the second alignment film and includes liquid crystal molecules and a polymeric material,
wherein
the first alignment film has a first rubbing axis,
the second alignment film has a second rubbing axis,
an angle between the first rubbing axis and the second rubbing axis is from 150° to 210° inclusive, and
the liquid crystal molecules have a negative dielectric anisotropy.

2. The transmissive screen according to claim 1, wherein a pretilt angle of some of the liquid crystal molecules that are in contact with the first alignment film and some of the liquid crystal molecules that are in contact with the second alignment film is from 0° to 80° inclusive.

3. The transmissive screen according to claim 2, wherein the pretilt angle of some of the liquid crystal molecules that are in contact with the first alignment film and some of the liquid crystal molecules that are in contact with the second alignment film is from 0° to 45° inclusive.

4. The transmissive screen according to claim 1, wherein a pretilt angle of some of the liquid crystal molecules that are in contact with the second alignment film differs from a pretilt angle of some of the liquid crystal molecules that are in contact with the first alignment film.

5. The transmissive screen according to claim 1, wherein a difference between a refractive index in a long axis direction of the liquid crystal molecules in a non-voltage applied state and a refractive index of the polymeric material in the non-voltage applied state is 0.05 or less.

6. The transmissive screen according to claim 1, wherein a thickness of the liquid crystal layer is from 2 μm to 20 μm inclusive.
